(19) United States
(12) Patent Application Publication
(10) Pub. No.: US 2009/0180641 A1
(43) Pub. Date: Jul. 16, 2009

(54) Method and apparatus for transmitting and receiving data using a phase or frequency modulated audio signal

(76) Inventors: Jack Ivan J'maev, Chino, CA (US); Addison Brooke Jones, Yorba Linda, CA (US)

Correspondence Address: INTELLECTUAL PROPERTY DEVELOPMENT;JACK IVAN J'MAEV, 14175 TELEPHONE AVE., SUITE L, CHINO, CA, 91710, US

(21) Appl. No.: 12/283,497

(22) Filed: Sep. 13, 2008

Related U.S. Application Data
(60) Provisional application No. 60/993,736, filed on Sep. 15, 2007.

(51) Int. Cl. H04B 15/00

(52) U.S. Cl. 381/94.8

(57) ABSTRACT

A method and system for transmitting and receiving a data stream using a phase or frequency modulated audio signal wherein an audio signal is modulated in at least one of phase and frequency according to the data stream and wherein the modulated audio signal is outside the range of human hearing. The modulated audio signal is combined with an audio program into a composite signal that is used to modulate a carrier. In order to receive the data easily, the audio program is filtered to accommodate the modulated audio signal. During reception, the gain of a detector is controlled by the power level of the recovered data-modulated audio signal. Recovery of the data-modulated audio stream is accomplished by first recovering the composite signal from the modulated carrier and attenuating the audio program so as to isolate the data-modulated audio signal. The isolated data-modulated audio signal is then again demodulated to recover the transmitted data.

### RELATED APPLICATIONS

The present application claims priority to U.S. provisional application No. 60/993,736 filed on Sep. 15, 2007 by Jack J'maev et al. entitled “Method and Apparatus for Transmitting and Receiving Data Using a Phase or Frequency Modulated Audio Signal” which is incorporated herein by reference in its entirety.

### BACKGROUND

Bandwidth is always a scare commodity. As such, many novel techniques have evolved for wireless transmission of data. However, many such techniques require a dedicated transmission channel. In some cases, a transmission channel can be shared so long as the transmission channel can be somehow segregated into different spectrums. For example, an audio transmission channel can be used to transmit digital data along with the audio data, but this normally requires significant signal processing in a receiver in order to extract the digital data in the presence of the audio data.

Depending on the primary means for modulating a carrier signal, there can be other effects that can mutate the digital data that is carried along with the audio data. The fact that the strength of a carrier signal can vary over time requires within a receiver an automatic gain control circuit, and this also can mutate a data signal.

### BRIEF DESCRIPTION OF THE DRAWINGS

Several alternative embodiments will hereinafter be described in conjunction with the appended drawings and figures, wherein like numerals denote like elements, and in which:

FIG. 1 is flow diagram that depicts one example method for transmitting data using a modulated audio signal;

FIG. 2 is a flow diagram that depicts one illustrative method for generating an audio signal;

FIG. 3 is a flow diagram that depicts an illustrative variation of the present method for setting the amplitude of a generated data modulated audio signal;

FIG. 4 is a flow diagram that depicts various alternative methods for modulating a data modulated audio signal;

FIG. 5 is flow diagram that depicts alternative methods for modulating a carrier wave;

FIG. 6 is a flow diagram that depicts one example method for receiving data that is carried by a data modulated audio signal;

FIG. 7 is a flow diagram that depicts alternative variations for demodulating a carrier wave;

FIG. 8 is a flow diagram that depicts one variation of the present method for isolating the data modulated audio signal from the audio program;

FIG. 9 is a flow diagram that depicts various alternative methods for demodulating an isolated data modulated audio signal;

FIG. 10 is a block diagram that depicts various alternative embodiments of a system for conveying data using a data modulated audio signal;

FIG. 11 is a block diagram that depicts alternative example embodiments of a signal injector; and

FIG. 12 is a pictorial diagram that depicts several frequency domain aspects of the audio program and data modulated audio signal.

### DETAILED DESCRIPTION

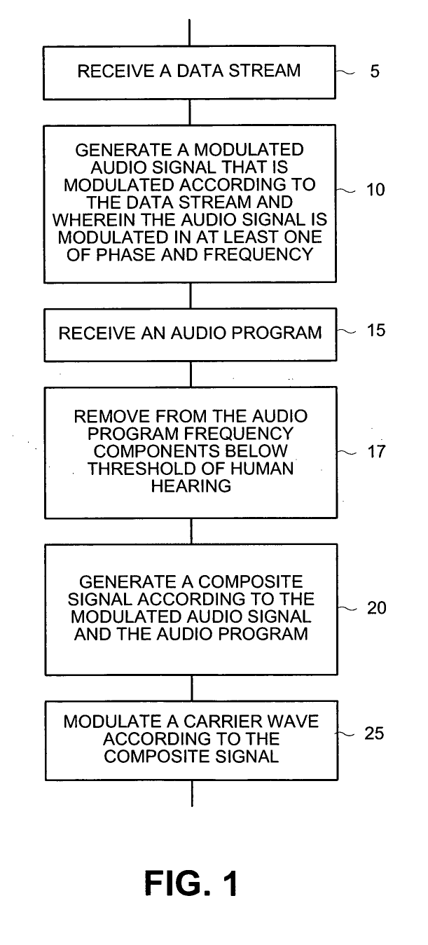

FIG. 1 is flow diagram that depicts one example method for transmitting data using a modulated audio signal. According to this example method, a data stream which is to be transmitted is first received (step 5). Once the data stream is received, a modulated audio signal is generated (step 10). Typically, the modulated audio signal is generated at a frequency that is below the range of human hearing. However, the modulated signal, according to various alternative embodiments, may be generated ay any frequency that is outside the range of human hearing (i.e. either above or below the normal range of audio that is perceptible by human beings). According to one variation of the present method, the audio signal is modulated in phase according to the data stream. In yet another variation of the present method, the audio signal is modulated in frequency according to the data stream. An audio program is then received (step 15). In order to facilitate demodulation of the modulated audio signal within a receiver, frequency artifacts that may be present in the audio program that are below the range of human hearing are removed from the audio program. In another alternative embodiment, frequency artifacts are removed within a range of the data modulated signal where such modulated signal is either above or below the range of human hearing. In furtherance of this example of the present method, a composite signal is generated (step 20). The composite signal is generated, according to yet another variation of the present method, by summing together the received audio program and the newly generated data modulated audio signal. This composite signal is then used to modulate a carrier wave (step 25). The carrier wave may then be transmitted or broadcast either to a single or a plurality of receivers, respectively. The carrier wave, according to various alternative methods, is modulated either in amplitude, phase, frequency or any combination thereof.

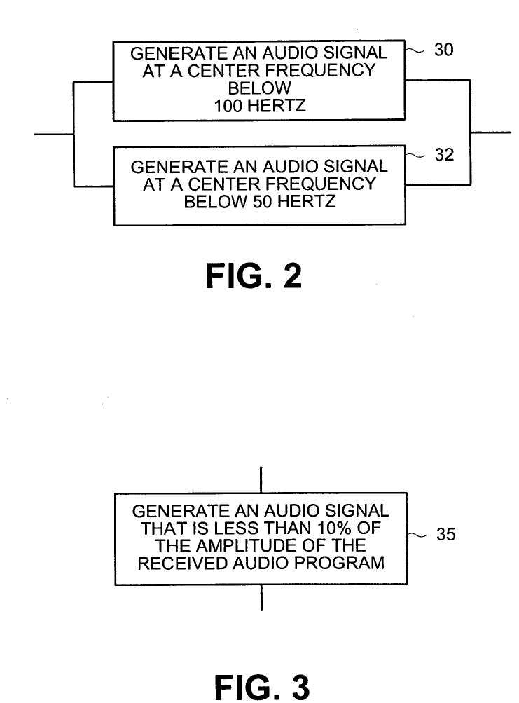

FIG. 2 is a flow diagram that depicts one illustrative method for generating an audio signal. According to one illustrative use case, the present method may be used for transmitting data into background of an audio program. For example, this illustrative method may be used to transmit data into background of a radio program. Irrespective of whether the radio program is transmitted by analog or digital transmission means, the present method may be applied. Typically, an audio program carried by a radio station will have very few frequency components below 100 hertz. Accordingly, an signal that is modulated by digital data may be centered below 100 Hertz. However, may radio stations provide for a lower frequency of 50 hertz in their audio programming. It should likewise be appreciated that, according to one variation of the present method, receiving an audio program according to the present method also includes the step of attenuating low frequency components that may be included in the received audio program. For example, one variation of the present method provides for attenuating frequency components below 100 hertz that may otherwise be present in the received audio program. In yet another variation of the present method, frequency components below 50 hertz that may be included in the received audio program are attenuated. By attenuating these lower frequency components, they are less likely to interfere with a data modulated audio signal that is combined with the audio program. In order to facilitate the present method, the data modulated audio signal generated in step 10 of the present method, according to one variation thereof, is generated at a frequency below 100 hertz (step 30). In yet another variation of the present method, the data modulated audio signal is generated at a frequency below 50 hertz. By confining the data modulated audio signal to these lower frequency ranges, it becomes easier to isolate the data modulated audio signal once it is received in a receiver. This is discussed in greater detail below.

FIG. 3 is a flow diagram that depicts an illustrative variation of the present method for setting the amplitude of a generated data modulated audio signal. It should further be appreciated that the typical radio station will seek to modulate a carrier wave, either in amplitude or frequency, in order to maximize the representation of an audio program in the transmitted carrier wave. Accordingly, the present method respects the fact that is important to maintain a high level of modulation of the carrier wave that is representative of the audio program. As such, one variation of the present method provides for generating a data modulated audio signal that less than 10 percent (step 35) of the amplitude of the received audio program. In yet another variation of the present method, which may be utilized in amplitude modulation broadcast radio, a 6% limitation is imposed upon the data modulated audio signal in order to comply with Federal Communications Commission's requirements for the transmission of subaudible tones.

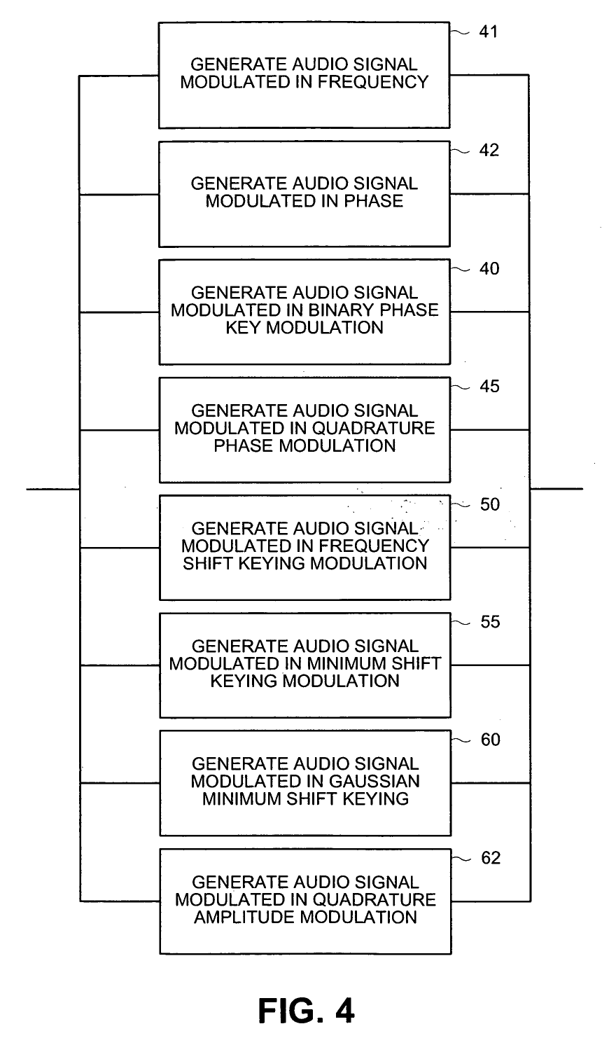

FIG. 4 is a flow diagram that depicts various alternative methods for modulating a data modulated audio signal. It should be appreciated that the data modulated audio signal may be modulated using various techniques. In one variation of the present method, the data modulated audio signal is modulated in frequency (step 41). In another illustrative variation of the present method, the audio signal is modulated in phase (step 42). For example, one variation of the present method provides that the audio signal is generated using binary phase key modulation (step 40). In yet another variation of the present method, the data modulated audio signal is modulated using a quadrature phase modulation (step 45). In yet another variation of the present method, the data modulated audio signal is modulated using frequency shift keying modulation (step 50). And in yet another variation of the present method, the data modulated audio signal is modulated using minimum shift keying (MSK) modulation (step 55). In yet another variation of the present method, Gaussian minimum shift keying is employed (step 60) as a means for modulating the data modulated audio signal. And in yet another illustrative method, quadrature amplitude modulation is used to modulated the data modulated audio signal (step 62).

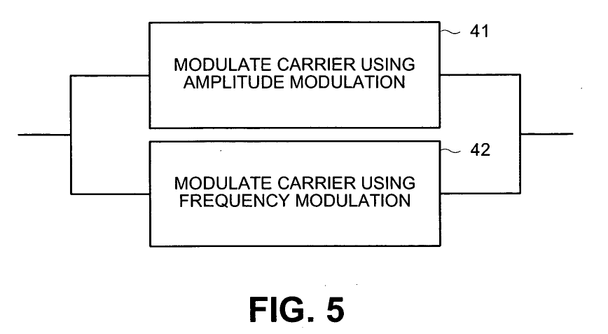

FIG. 5 is flow diagram that depicts alternative methods for modulating a carrier wave. To be appreciated that the composite signal may be used to modulate a carrier wave, which is then either transmitted or broadcast to one or a plurality of receivers as the case may be. In one variation of the present method, the composite signal is used to modulate a carrier wave using amplitude modulation (step 65). In this case, the amplitude of interior wave is varied according to the composite signal. In yet another variation of the present method, the composite signal is used to modulate a carrier wave using frequency modulation (step 70). In this case, the frequency of the carrier wave is varied according to be composite signal. It should be appreciated that the composite signal in either of these cases includes an audio program component and a data modulated audio signal.

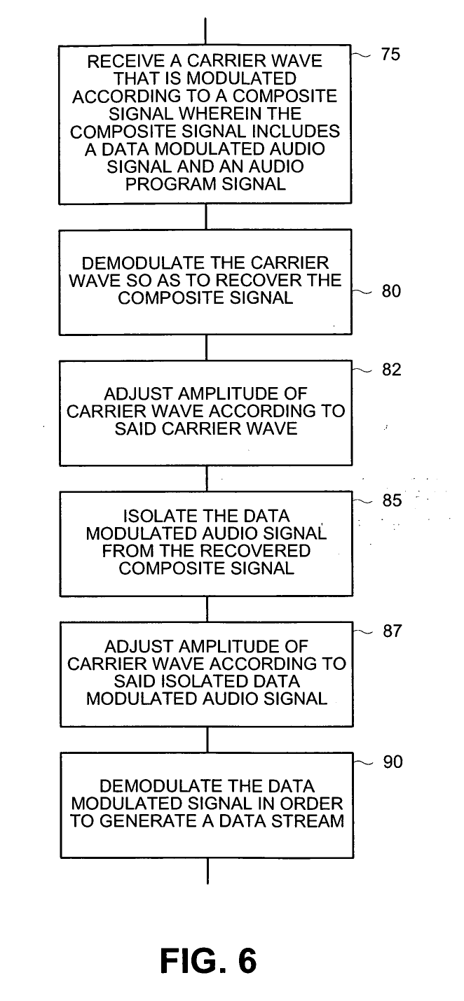

FIG. 6 is a flow diagram that depicts one example method for receiving data that is carried by a data modulated audio signal. In this example variation of the present method, a carrier wave that is modulated according to a composite signal is received (step 75). In many cases, the strength of the received carrier wave will vary over a range of signal strengths. Accordingly, this variation of the present method provides for adjusting the amplitude of the carrier wave so that a wide range of input signal strengths can be accommodated. There are actually several ways to adjust the amplitude of the received carrier wave. In a preferred illustrative method, the amplitude of the carrier wave is adjusted according to the carrier wave itself (step 82). In lay terms, the output of the receiving process adjusts an amount of amplification applied to the received carrier wave in order to maintain the output of such amplification at a substantially constant level. It should be appreciated that the composite signal includes a data modulated audio signal and an audio program signal. The carrier wave is then demodulated in order to recover the composite signal (step 80). Once the composite signal is recovered through the demodulation process, the data modulated audio signal is isolated from the audio signal included in the composite signal (step 85). At this stage of the process, if the carrier wave being received were to vary in strength, the amplitude of the isolated audio signal may also vary as a result of an attempt to maintain a constant level of the carrier wave. Typically, an automatic gain control circuit is provided to maintain the proper level of the carrier wave before it is demodulated.

Especially where the carrier wave is modulated using amplitude modulation, an automatic gain control circuit would respond to the predominate modulating signal, that of an audio program. The reader is reminded that the audio program, in a typical AM broadcast system, will account for 94% of the modulation and the data modulated audio signal will account for only 6% of the modulation. Because the automatic gain control circuit will respond to the predominate modulation of the audio program, the data modulated audio signal may be mutated so severely that demodulation becomes impossible. This mutation would occur because the carrier level presented to a demodulating circuit would vary significantly when compared to the power level of the data modulated audio signal. As such, in this example method, the amplitude of the carrier wave is adjusted according to the amplitude of the data modulated audio signal once the audio signal is isolated from the remaining portion of the composite signal (step 87). Once the data modulated audio signal is isolated, it is itself demodulated in order to recover a data stream (step 90). It should be appreciated that in one variation of the present method, continuous adjustment of the amplitude of the carrier wave is accomplished in a manner that is relatively slow compared to that of the symbol rate of the modulated audio signal. In other words, this alternative method does not rely on adjusting the amplitude of the carrier wave according to the isolated audio signal that is modulated with data. In this alternative method, the time constant of the carrier level adjustment is fixed to an amount greater than the symbol rate of the data encoded onto the isolated data modulated audio signal. In an alternative method, adjustment of the carrier wave amplification is at first accomplished at a rapid time constant in order to accommodate variations in the carrier caused by the audio program and the larger time constant is used once the data modulated audio signal is isolated from the composite signal.

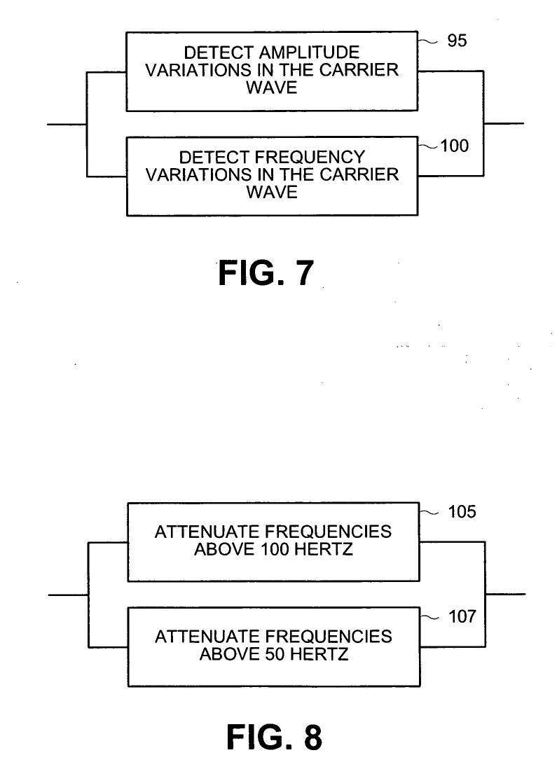

FIG. 7 is a flow diagram that depicts alternative variations for demodulating a carrier wave. According to one variation of the present method, the carrier wave is demodulated by detecting amplitude variations in the carrier wave (step 95). In this variation of the present method, variations in amplitude result in composite signal that includes both the data modulated audio signal and the audio program. In yet another variation of the present method, variations in the frequency of the carrier wave are detected (step 100). In this variation of the present method, variations in frequency result in a composite signal that includes both the data modulated audio signal and the audio program.

FIG. 8 is a flow diagram that depicts one variation of the present method for isolating the data modulated audio signal from the audio program. According to this variation of the present method, the data modulated audio signal is isolated from the audio program included in the composite signal by subjecting the composite signal to a frequency selective attenuation. According to one variation of the present method, frequencies above 100 hertz (step 105) are attenuated in deference to lower frequency components included in the composite signal. As such, the data modulated audio signal which is centered below 100 hertz will pass through the frequency selective attenuation whereas the audio program will not. According to another variation of the present method, frequencies above 50 hertz (step 107) are attenuated in deference to lower frequency components included in the composite signal. As such, the data modulated audio signal which is centered below 50 hertz will pass through the frequency selective attenuation whereas the audio program will not. It should also be appreciated that, according to one variation of the present method, the data modulated audio signal will be centered at a frequency greater than that normally perceptible by the human ear. As such, this variation of the present method provides for attenuating an audio program that comprises lower frequencies components, for example by using a high pass filter in order to isolate the data modulated audio signal from the audio program.

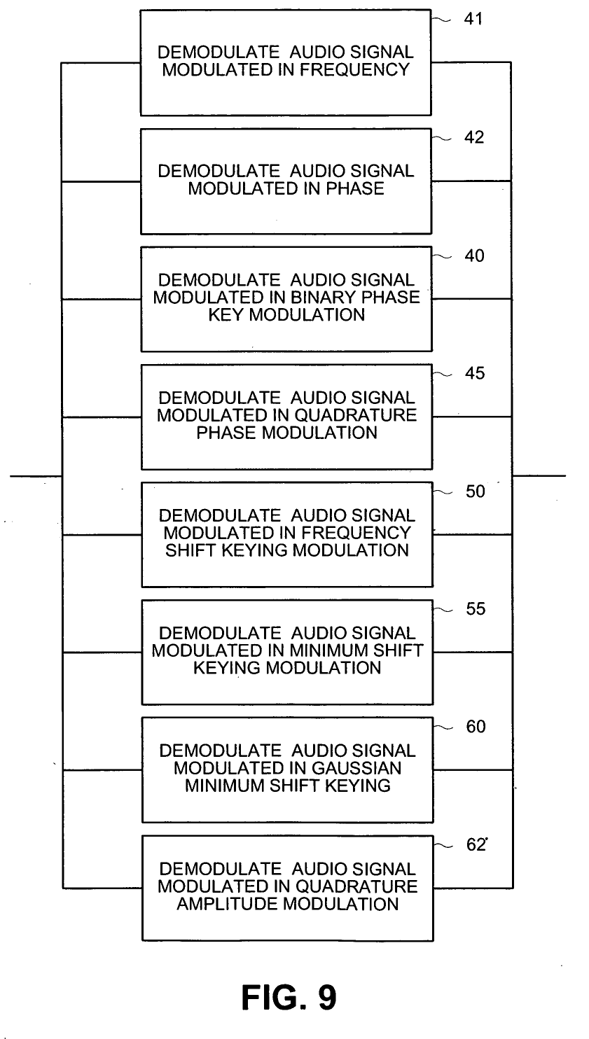

FIG. 9 is a flow diagram that depicts various alternative methods for demodulating an isolated data modulated audio signal. In one example alternative method, the isolated data modulated audio signal is demodulated using a frequency demodulation (step 112). In another example alternative method, the isolated data modulated audio signal is demodulated using a phase demodulation (step 117). In one variation of the present method the isolated data modulated audio signal is demodulated using binary phase key demodulation (step 110). In yet another variation of the present method, the data modulated audio signal is demodulated using a quadrature phase demodulation (step 115). In yet another variation of the present method, the data modulated audio signal is demodulated using frequency shift keying demodulation (step 120). And in yet another variation of the present method, the data modulated audio signal is demodulated using minimum shift keying demodulation (step 125). In yet another variation of the present method, Gaussian minimum shift keying is employed (step 130) as a means for demodulating the data modulated audio signal. And in yet another variation of the present method, quadrature amplitude demodulation is used to recover data from the isolated data modulated audio signal (step 132).

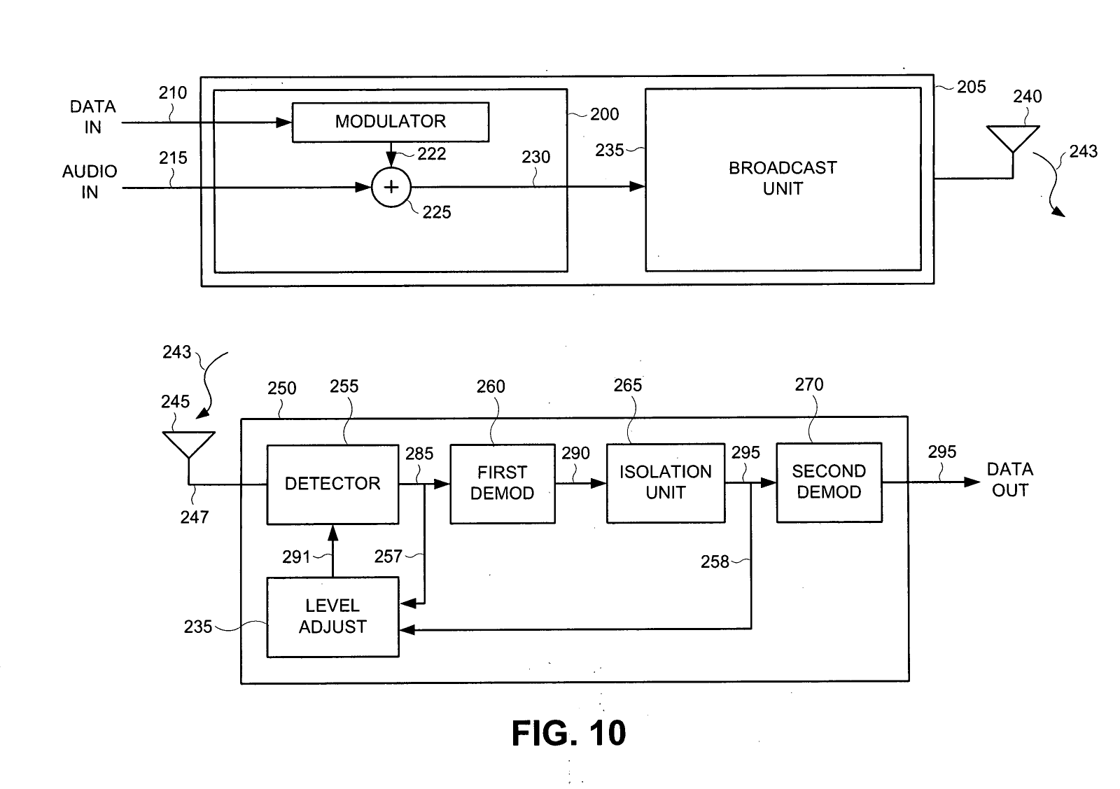

FIG. 10 is a block diagram that depicts various alternative embodiments of a system for conveying data using a data modulated audio signal. According to one example embodiment, a system includes a central unit 205 and a receiver 250. In one alternative embodiment, the central unit comprises a signal injector 200. In yet another alternative embodiment, the central unit further comprises a broadcasting unit 235. And in yet another alternative embodiment, the central unit 205 further comprises a radiator 240.

According to one example embodiment, the signal injector 200 includes a data port 210, which is used to receive data that is to be transmitted to the receiver 250. The signal injector 200 also includes an audio port 215. The audio port 215 is used to receive an audio program, for example from a radio station audio program feed. In this example embodiment, the signal injector 200 also includes a modulator 220. The modulator 220 receives a data stream by means of the data port 210. The data stream is that used as the basis of a data modulated audio signal 222, which is generated by the modulator 220. The modulator 220, according to various alternative embodiments, comprises at least one of a phase modulator, a frequency modulator, a binary phase key modulator, a quadrature phase modulator, a frequency shift keying modulator, a minimum shift keying modulator, a Gaussian minimum shift keying modulator and a quadrature amplitude modulator.

The output of the modulator 220 is then combined with the audio program by means of a combiner 225. In one alternative embodiment, the combiner 225 comprises a summing unit. The output of the combiner 225 comprises a composite signal 230, which includes the audio program received by the audio port 215 and the data modulated audio signal 222 generated by the modulator 220. The composite signal 230 is then directed from the signal injector 200 to a broadcast unit 235, which is included in one alternative example embodiment of a central unit 205. The broadcast unit 235 generates a carrier wave which is modulated according to the composite signal 230. The broadcast unit 235 directs the carrier wave to radiator 240, which is included in one alternative embodiment and which radiates a modulated carrier wave 243 into free space.

According to one alternative embodiment, the receiver 250 includes an antenna 245 for receiving a radiated carrier wave 243, the source of which is the radiator 240 included in one alternative embodiment of the central unit 205. Included in this example embodiment of a receiver 250 is a detector 255. The detector 255 receives an electrical signal 247 from the antenna 245 and isolates the carrier wave from other signals that may be received by the antenna 245. For example, the detector ordinarily comprises a tuning mechanism which filters out unwanted signals and amplifies the desired signal i.e. the carrier wave 243 emanating from the radiator 240. A first demodulator 260 included in this example embodiment of the receiver 250 receives the detected carrier wave 285 from the detector 255 and demodulates (i.e. recovers) a composite signal 290 from the carrier wave 285. In one alternative embodiment, this first demodulator 260 comprises in amplitude modulation demodulator. In yet another alternative embodiment, this first demodulator 260 comprises a frequency modulation demodulator. The composite signal 290 includes an audio program and a data modulated audio signal. The composite signal 290 is then directed to an isolation unit 265, which is included in this alternative embodiment and which isolates the data modulated audio signal from the audio program and directs the data modulated audio signal 295 to a second demodulator 270. According to one alternative embodiment, the isolation unit 265 comprises a frequency selective attenuator, e.g. a filter. In yet another alternative embodiment, the isolation unit 265 comprises a filter that allows frequencies of less than 100 hertz to pass on to the second demodulator 270. In another embodiment, the filter allows frequencies less than 50 hertz to pass on to the second demodulator 270. In yet another embodiment, the isolation unit comprises a band-pass filter that selects a small band that encompasses the data modulated audio signal. In yet another embodiment, the isolation unit comprises a high-pass filter that allows a data modulated signal to pass to the second demodulator and precludes an audio program having lower frequency components to be attenuated.

The second demodulator 270 included in this illustrative embodiment recovers a data stream 280 from the data modulated audio signal 295. The second demodulator 270, according to various alternative embodiments, comprises at least one of a phase demodulator, a frequency demodulator, a binary phase key demodulator, a quadrature phase demodulator, a frequency shift keying demodulator, a minimum shift keying demodulator, a Gaussian minimum shift keying demodulator and a quadrature amplitude demodulator. It to be appreciated that the receiver described as far comprises a stand-alone data receiver according to one alternative embodiment claimed herein.

This example embodiment of a receiver further comprises a level adjustment unit 256 (i.e. an automatic gain controller). In this example embodiment, the level adjustment unit provides an adjustment signal 291 to the detector 255. The detector adjusts the amount of amplification applied to the input signal 247 according to the adjustment signal 291. The level adjustment signal 291 is generated according to the signal level of the isolated carrier wave 257. Once the isolation unit 265 is able to isolate a isolate the data modulated audio signal, the level adjustment unit 256 uses the power level 258 of the isolated audio signal as a basis for the level adjust signal 291. In one alternative embodiment, the level adjust signal ignores the signal level of the isolated audio signal and simply applies a large time constant to the level of the isolated carrier wave 257. In yet another alternative embodiment, the level adjustment unit 256 uses a rapid time constant in order to initially set the level of the isolated carrier wave and then uses a larger time constant once the isolation unit 265 is able to isolate the data modulated audio signal. In either of these embodiments, the larger time constant applied to the level of the isolated carrier wave 257 is greater than the symbol rate of the data encoded onto the isolated audio signal.

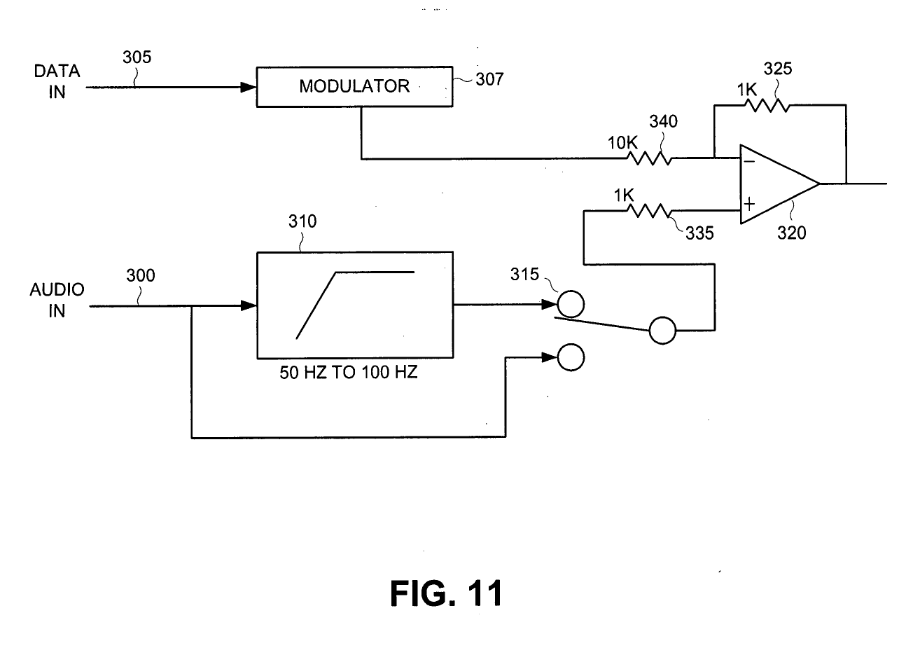

FIG. 11 is a block diagram that depicts alternative example embodiments of a signal injector. According to this example embodiment, a signal injector 200 includes a data port 305 for receiving data, an audio port 300 for receiving an audio program, a modulator 307 and a combiner 320. In this example embodiment, the combiner 320 comprises a summing circuit based on an operational amplifier. In one example embodiment, a summing circuit includes a feedback resistor 325 and two input resistors (330, 335). In order to ensure that the level of a data modulated audio signal 340 generated by the modulator 307 does not exceed approximately 10 percent of the amplitude of an audio program perceived by the audio input 300, this example embodiment provides for setting the sensitivity of one input of the summing circuit to approximately 1/10 of the sensitivity of the other input of the summing circuit. The input with lower sensitivity receives the output of the modulator 307 whereas the input with the higher sensitivity receives the audio program. As an alternative embodiment, the output level of the modulator 307 is adjusted to be no more than 10 percent of the level of the audio program received by the audio input 300. In this case, the sensitivity of both input of the summing circuit are configured to be substantially equal. In yet another alternative embodiment, the modulator 307 generates a data modulated audio signal that is centered at a frequency of less than 100 Hz commensurate with the teachings of the present method. Also, one alternative embodiment of the signal injector 200 further comprises a filter 310 for attenuating those frequency components of an audio program that would otherwise interfere with the data modulated audio signal generated by the modulator 317. Commensurate with the teachings of the present method and various alternatives thereof, the filter 310 comprises at least one of a filter that attenuates frequencies below that of normal human nearing; a filter that attenuates frequencies above that of normal hearing; a filter that attenuates frequencies below 100 hertz; a filter that attenuates frequencies below 50 hertz; and a filter that attenuates frequencies in a spectral range that would otherwise interfere with the data modulated audio signal.

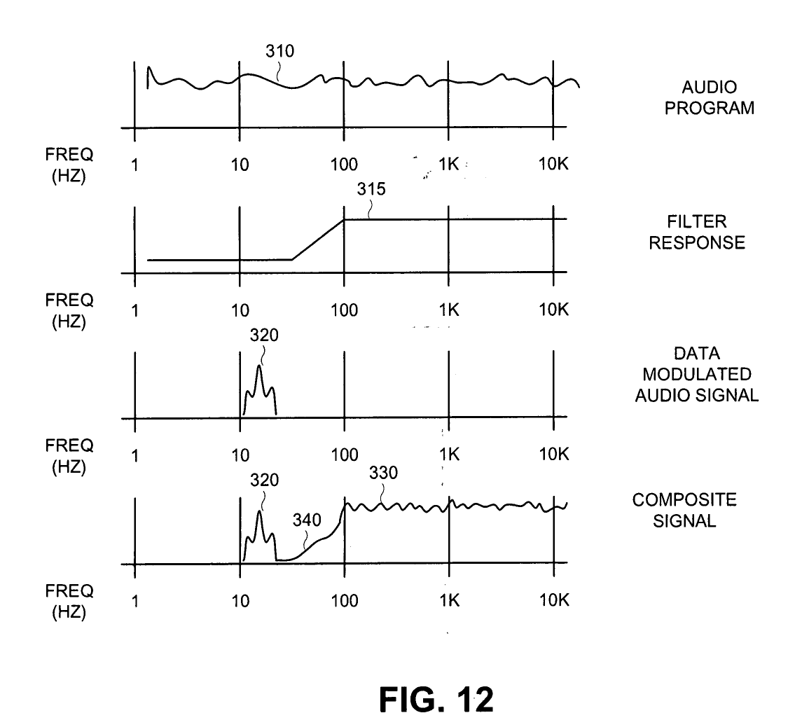

FIG. 12 is a pictorial diagram that depicts several frequency domain aspects of the audio program and data modulated audio signal. As already discussed above, an audio program received by the signal injector 200 may have frequency components 310 from a low frequency range through a high frequency range, even beyond the range of human hearing. This is shown in the spectral diagram “A”. Spectral diagram “B” shows one alternative spectral profile 320 for a data modulated audio signal. In order to preclude interference to the data modulated audio signal 320 by the audio program 310, a filter is applied to the audio program wherein the filter has a response 315 that attenuates the audio program in a spectral region commensurate with the spectral profile 320 of the data modulated audio signal as shown in spectral diagram “C”. When the filtered audio is combined with the data modulated audio signal, the interference 340 by the audio program upon the data modulated audio signal 320 is significantly reduced, as depicted spectral diagram “D”.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for transmitting data comprising:
receiving a data stream;
generating a modulated audio signal that is modulated according to the data stream and wherein the audio signal is modulated in at least one of phase and frequency and where in the modulated audio signal is below the threshold of human hearing;
receiving an audio program;
removing from the audio program that frequency spectrum that is below the threshold of human hearing;
generating a composite signal by combining the modulated audio signal with the audio program; and
modulating a carrier wave according to the composite signal.

2. The method of claim 1 wherein the generated audio signal is generated at a center frequency below 100 Hertz or below 50 Hertz.

3. The method of claim 1 wherein the amplitude of the generated audio signal is less than 10% of the amplitude of the received audio program.

4. The method of claim 1 wherein the generated audio signal is modulated according to the data stream using at least one of frequency modulation, phase modulation, binary phase key modulation, quadrature phase modulation, frequency shift keying, minimum shift keying, Gaussian minimum shift keying and quadrature amplitude modulation.

5. The method of claim 1 wherein the carrier wave is modulated according to the composite signal using at least one of amplitude modulation and frequency modulation.

6. A method for receiving data comprising:
receiving a carrier wave that is modulated according to a composite signal wherein the composite signal includes a data modulated audio signal and an audio program signal;
adjusting the amplitude of the carrier wave in order to accommodate a range of received signal strengths wherein such adjustment is accomplished by monitoring the amplitude of the amplitude of the carrier wave;
demodulating the carrier wave so as to recover the composite signal;
isolating the data modulated audio signal from the recovered composite signal;
continuing to adjust the amplitude of the carrier wave in order to accommodate a range of received signal strengths wherein such adjustment is accomplished by monitoring the amplitude of the data modulated audio signal; and
demodulating the data modulated signal in order to generate a data stream.

7. The method of claim 6 wherein demodulating the carrier wave comprises at least one of detecting amplitude variations in the carrier wave and detecting frequency variations in the carrier wave.

8. The method of claim 6 wherein isolating the data modulated signal comprises attenuating frequencies above 100 Hertz or attenuating frequencies above 50 Hertz.

9. The method of claim 6 wherein demodulating the data modulated signal comprises demodulating the data modulated signal using at least one of frequency modulation, phase modulation, binary phase key demodulation, quadrature phase demodulation, frequency shift keying demodulation, minimum shift keying demodulation, Gaussian minimum shift keying demodulation and quadrature amplitude modulation.

10. A system for conveying data comprising:
central unit comprising:
data port for receiving data;
audio port for receiving an audio program;
filter for attenuating frequency components included in the audio program that are inaudible to a human listener;
modulator that generates a data modulated audio signal that is modulated according to the received data wherein said modulator comprises at least one of a phase modulator and a frequency modulator; and
combiner that generates a composite signal by combining the audio program with the data modulated audio signal;
broadcast unit that generates a carrier wave that is modulated according to the composite signal; and
radiator that radiated the generated carrier wave;
receiver comprising:
antenna for receiving the radiated carrier wave in addition to other radiated signals;
detector that recovers that isolates the carrier wave from other signals received by the antenna;
first demodulator that recovers the composite signal from the isolated carrier wave;
isolation unit that isolates the data modulated audio signal from the composite signal;
second demodulator that recovers the data stream from the isolated data modulated audio signal; and
level adjustment device that enables the detector to detect a radiated carrier wave over a range of signal strengths where said adjustment is first accomplished according to the strength of the isolated carrier wave and is then accomplished according to the level of the isolated data modulated audio signal.

11. The system of claim 10 wherein the modulator comprises at least one of a frequency demodulator, a phase demodulator, binary phase key modulator, quadrature phase modulator, frequency shift keying modulator, minimum shift keying modulator, Gaussian minimum shift keying modulator and a quadrature amplitude demodulator.

12. The system of claim 10 wherein the broadcast unit comprises at least one of an amplitude modulation transmitter and a frequency modulation transmitter.

13. A signal injector comprising:
data port for receiving data;
audio port for receiving an audio program;
modulator that generates a data modulated audio signal that is modulated according to the received data wherein said modulator comprises at least one of a phase modulator and a frequency modulator;
filter that attenuates frequencies in the audio program that would interfere with the spectral profile of the data modulated audio signal; and
combiner that generates a composite signal by combining the audio program with the data modulated audio signal.

14. The data encoder of claim 13 wherein the modulator generates a data modulate signal that is at a frequency of less than 100 hertz or of less than 50 hertz.

15. The data encoder of claim 13 wherein the modulator generates a data modulated signal that is less than 10% of the amplitude of an audio program received by the audio port.

16. A data receiver comprising:
detector that isolates a carrier wave from other signals received by an antenna;
first demodulator that recovers a composite signal from the carrier wave wherein the composite signal includes an audio program and a data modulated audio signal;
isolation unit that isolates the data modulated audio signal from the composite signal;
second demodulator that comprises at least one of a frequency demodulator and a phase demodulator and that recovers the data stream from the isolated data modulated audio signal;
automatic gain control that enables the detector to receive a carrier wave over a range of signal strength where the automatic gain control adjusts the detector according to the strength of the isolated carrier wave and then adjusts the detector according to the isolated data modulated audio signal.

17. The data receiver of claim 16 wherein the detector comprises at least one of an amplitude modulation receiver and a frequency modulation receiver.

18. The data receiver of claim 16 wherein the isolation unit comprises a low-pass-filter configured to pass frequencies less than 100 hertz.

19. The data receiver of claim 16 wherein the second demodulator comprises at least one of a frequency demodulator, a phase demodulator; binary phase key demodulator, quadrature phase demodulator, frequency shift keying demodulator, minimum shift keying demodulator, Gaussian minimum shift keying demodulator and a quadrature amplitude demodulator.
